(19) United States
(12) Patent Application Publication
(10) Pub. No.: US 2020/0334761 A1
(43) Pub. Date: Oct. 22, 2020

(54) SYSTEMS AND METHODS FOR GEOREFERENCING AND SCORING VEHICLE DATA IN COMMUNITIES

(71) Applicant: OCTO TELEMATICS SPA, Rome (IT)

(72) Inventors: Ernesto VIALE, Rome (IT); Daniele TORTORA, Rome (IT); Claudia PROIA, Rome (IT); Maria FERRO, Rome (IT); Giovanni LIMA, Rome (IT); Pierpaolo PAOLINI, Rome (IT)

(21) Appl. No.: 16/311,014

(22) PCT Filed: Jul. 5, 2017
(86) PCT No.: PCT/IB2017/054043

§ 371 Date: Dec. 18, 2018

(30) Foreign Application Priority Data
Jul. 7, 2016 (IT) 102016000071099

(51) Int. Cl. G06Q 40/08; G06Q 30/02

(52) U.S. Cl. CPC G06Q 40/08; G06Q 30/0205

(57) ABSTRACT

A computer system for assessing vehicle risk can include: a data storage device storing instructions; a data processor that is configured to execute the instructions to cause the computer system to: provide aggregated vehicle data for a plurality of vehicles including location data of the plurality of vehicles; determine at least one geographic area to be analyzed for the aggregated vehicle data; receive event information of the plurality of vehicles in the at least one geographic area, the even information including location information of a predetermined type of event; determine boundaries of a plurality of geographic communities within the at least one geographic area based on the received event information of the plurality of vehicles; and assigning a risk profile to each of the determined geographic communities based on the event information in each geographic community.

### TECHNICAL FIELD

The present invention relates to systems and methods for use in aggregating, organizing and scoring vehicle data, especially with regard to geographical areas of risk.

### BACKGROUND

Insurance is becoming more of a commodity within the policyholder market thus insurance companies are often chosen according to price offering. On the other hand an accurate ratemaking has become more important than ever for the Insurance Company. A critical question in ratemaking is: “What risk factors or variables are important for predicting the likelihood, frequency and severity of claims?”

Although there are many obvious risk factors that affect rates, non-intuitive relationships can exist among variables that are difficult, if not impossible, to identify without applying more sophisticated analysis.

What is needed are systems and methods of aggregating and scoring vast amounts of vehicle data.

### SUMMARY

A computer system for assessing vehicle risk can include: a data storage device storing instructions; a data processor that is configured to execute the instructions to cause the computer system to: provide aggregated vehicle data for a plurality of vehicles including location data of the plurality of vehicles; determine at least one geographic area to be analyzed for the aggregated vehicle data; receive event information of the plurality of vehicles in the at least one geographic area, the even information including location information of a predetermined type of event; determine boundaries of a plurality of geographic communities within the at least one geographic area based on the received event information of the plurality of vehicles; and assigning a risk profile to each of the determined geographic communities based on the event information in each geographic community.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE FIGURES

shows a framework for receiving and organizing vehicle data, according to an embodiment of the invention.

FIG. 2 shows a framework for receiving and organizing vehicle data, according to an embodiment of the invention.

FIG. 3 shows a flowchart for receiving and organizing data, according to an embodiment of the invention.

FIGS. 4A-4C show various area/communities of different risk within a community, according to an embodiment of the invention.

FIG. 5 shows weather data of communities, according to an embodiment of the invention.

FIG. 6 shows speed and distribution by community of vehicles, according to an embodiment of the invention.

FIG. 7 shows a score distribution of various variables, according to an embodiment of the invention.

FIG. 8 shows a driving pattern in relation to a particular context with a corresponding distribution, according to an embodiment of the invention.

### DESCRIPTION

Some embodiments of the current invention are discussed in detail below. In describing embodiments, specific terminology is employed for the sake of clarity. However, the invention is not intended to be limited to the specific terminology and examples selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

The term “computer” is intended to have a broad meaning that may be used in computing devices such as, e.g., but not limited to, standalone or client or server devices. The computer may also include an input device including any mechanism or combination of mechanisms that may permit information to be input into the computer system from, e.g., a user. The input device may include logic configured to receive information for the computer system from, e.g. a user. Examples of the input device may include, e.g., but are not limited to include, a mouse, penbased pointing device, or other pointing device such as a digitizer, a touch sensitive display device, and/or a keyboard or other data entry device. Other input devices may include, e.g., but are not limited to include, a biometric input device, a video source, an audio source, a microphone, a web cam, a video camera, and/or other camera. The input device may communicate with a processor either wired or wirelessly.

The term “data processor” is intended to have a broad meaning that includes, e.g., but is not limited to include, one or more central processing units that are connected to a communication infra-structure (e.g., but not limited to, a communications bus, cross-over bar, interconnect, or network, etc.). The term data processor may include any type of processor, microprocessor and/or processing logic that may interpret and execute instructions (e.g., for example, a field programmable gate array (FPGA)). The data processor may comprise a single device example, a single core) and/or a group of devices (e.g., multi-core). The data processor may include logic configured to execute computer-executable instructions configured to implement one or more embodiments.

The term “data storage device” is intended to have a broad meaning that includes removable storage drive, a hard disk installed in hard disk drive, flash memories, removable discs, other types of memory, non-removable discs, Cloud storage such as Amazon, Apple, Dell, Google, Microsoft, etc., and other storage implementations. In addition, it should be noted that various electromagnetic radiation, such as wireless communication, electrical communication carried over an electrically conductive wire (e.g., but not limited to twisted pair, CATS, etc.) or an optical medium (e.g., but not limited to, optical fiber) and the like may be encoded to carry computer-executable instructions and/or computer data that embodiments of the invention on a communication network. These computer program products may provide software to the computer system. It should be noted that a computer-readable medium that comprises computer executable instructions for execution in a processor may be configured to store various embodiments of the present invention.

Disclosed is a general description of embodiments of the invention that can be provided to insurance companies that can identify and evaluate driving behaviors as well as geographical communities that correlate to the risk of an accident.

Embodiments of the invention relate to providing insurance Telematics services as well as pioneering applications in motor rental and fleet management, car manufacturing and governmental sectors. Embodiments of the invention can include using telematics data to determine how much risk is associated with a driver depending on how the driver drives. Also, embodiments of the invention can include using telematics data to determine how much risk is associated with geographical communities based on accident information. This service can provide a methodology that can be applied in scoring drivers based on aggregated vehicle data and predictive model techniques.

For many years, the risk of having an accident has been evaluated by insurance companies taking into account a number of statistical factors that have shown to be significant indicators (policyholder's sex, age, education, profession, zone of residence, vehicle type, etc.), as well as using historical records about the accidents that the policyholder may have caused in the last years.

Telematics allow introducing new indicators whose influence on the exposure to risk can be more direct than the traditional “indirect” indicators. “Telematics indicators” can also be evaluated dynamically (e.g., every month), while traditional indirect indicators can be inherently static. Telematics indicators can therefore be used to educate the policyholder to gradually reduce their exposure to risk. The “principle of transparency,” which is one of the cornerstones of the approach of embodiments of the present invention, can be ideal in this context to achieve mutual benefit for the driver and for the insurance company.

However, not all telematics indicators have achieved a level of public recognition and standardization that are sufficient for operational use. Some are more mature, some are less mature. This mostly depends on the availability of existing actuarial information that can be used to correlate the indicators to the objective evidence of risk. For such correlation, a number of driving patterns of an individual driving style can be assessed within a specific context in which has been generated. For example, a user may exhibit driving patterns in relation to various indicators. In addition to the driving pattern benchmarked against driving patterns of a population of drivers, community-specific accident information can be used so that a particular driver's driving pattern or destinations can be benchmarked against the crash information. This data can include specific information about accidents and crashes in geographical units, as explained in more detail below. The driver can be scored using a numerical or threshold scoring system to rate the driver in relation to the population.

FIG. 1 shows a flow diagram of how data in this context can be organized, applied and scored for particular applications. As can be seen from FIG. 1, sensors 110, car maker data 112, black boxes 114, and/or smart phones 116 can be used to provide data for users and/or vehicles.

These devices 110, 112, 114 and/or 116 can be configured to include computer components that are connectable to the Internet to enable them to be Internet of Things devices. These devices can be configured to communicate either hardwired or wirelessly with one or more Internet of Things hub stations 118. The hub station 118 may be of any type of device configured to interface with the Internet of Things devices and one or more communication networks.

Raw sensory data or readings may be interpreted with respect to physical environments, such as using situation/context-awareness, in order to provide semantics services. Some services may be time sensitive. For example, the actions for controlling physical environments may need to be performed over IoT devices in real-time fashion. A physical IoT device may provide multiple types of services or multiple IoT devices may collaborate or be grouped together to provide a service. This data can relate to accidents including severity, frequency and type of accident involved with a number of vehicles.

The data flow can proceed to a telematics device management module 120 that manages data coming from the IoT hub station 118. The data can also proceed to the telematics platform data streaming module 122. For traffic to and from a physical environment, physical IoT devices may generate data streams which may be event-driven, query-driven, or periodical in nature. There may be an uncertainty in the readings or raw sensory data from physical IoT devices. Some IoT devices, such as distributed cameras, may generate high-speed data streams, while other IoT devices may generate extremely low data rate streams. The data flow generated from most IoT devices is real-time data flow, which may vary in different time scale. There may be anycast, multicast, broadcast, and convergecast traffic modes. Geographical Information Service Data Services module 126 can interface with the acquired data in the telematics platform data streaming module 122, which can provide contextual information.

Embodiments of the invention can include a professional service which provides aggregated user profile Risk Scoring based on telematics data. Specifically, embodiments of the invention can enable customers to define the real risky behavior or geographical communities of driving.

“Risk Scoring Values by Profiles” can represent outcomes of a predictive model.

The origin of the service can rely on powerful and extensive Big Data environment collected over many years of telematics experience.

This data can be required for statistical validity of a car driver's population in terms of driving habits (information related to time, distance and place), driving behaviors (information related to acceleration, breakings, cornering, etc.) and external data information with significant number of registered crashes analyzed over space and time.

Embodiments of the invention aim to support insurance in launching a telematics program providing risk scoring for aggregated risk classes which are representative of insurance risk portfolio,

Risk scoring can be defined as a predictive model targeted on crash events leveraged on data collected over the years by various sensors and devices. Therefore the service can be used for risk oriented policy discounts based on a precise characterization of the policyholder's risk profile.

To handle the practical problem of identifying relationships of various risk factors, advanced analytical models can be used. Embodiments of the invention can include a Telematics service based on Big Telematics data which allows to rank each driver with respect to several driving style perspectives generated in a different context. Additionally, the driver may be ranked according to the crash information benchmarks of the driver's geographical driving patterns compared to the crash information of the driver population in those particular communities.

Advanced analytic techniques are useful to understand the relationships between multiple risk variables. Similarly to traditional predictive modeling, embodiments of the invention can make use of modeling using telematics variables. Insurance providers can use these models to accurately estimate losses and set the most competitive rates accordingly.

These models can be very powerful if applied to a large data-set, which is a context of the telematics environment, defining the most predictive factors and identify the ones with poor or not relevant discriminatory power.

A value of embodiments of the invention outcome relies on Big Data assets, specifically taking into account driving habits and behavior multivariate effects targeted with the probability to cause a crash event. Geographical locations of accidents can also be taken into account and even overlaid with the driving pattern information.

An objective of embodiments of the invention is to estimate a systematic relation between the insured and his/her risk profile. This can relate to generating geographical communities of risk based on crashes information. That is, based on accident frequency, severity, or type, some geographical regions or communities can be rated as more likely than others to experience an accident. The accident information can be incorporated into users' risk profile based on the extent to which the users drive in risky geographical communities. This process of characterizing or rating geographical communities for risk of accidents can be referred to as zoning or area classification.

Area classification is one of the main processes that influence a rate making process. In some embodiments, the process can include defining and classifying risky zone leveraging on geodemographic data such as urban density. In an embodiment, the process can utilize the Louvain Method with OPTGRAPH procedure in SAS.

The following is a brief description of Louvain algorithm:
Initially each node as its own community or area.
Move each node from its current community to the neighboring community that increase the modularity the most (Modularity is a measure of the quality of a division of a graph into communities). Repeat the steps until the modularity cannot further improved.
Group the nodes in each communities in a super node. Construct a new graph based on super nodes. Repeat the steps until the modularity cannot further improved or the maximum number of iterations has been reached.

In the case of our implementation, the algorithm is used to aggregate the micro-areas based on common characteristics (similar accommodation facility) as well as to define new neighboring geographic areas and as homogeneous as possible for these characteristics. The application is based on a geographical map due to a graph in which:
Each micro-area represents a node;
Two nodes are connected if the micro-areas that represent are among their neighbors;—The strength of the link is the degree of similarity between the two areas (in our case the variable used to define the strength of the bond is indicates the type of structure living area: the town, inhabited, industrial zone and scattered houses.

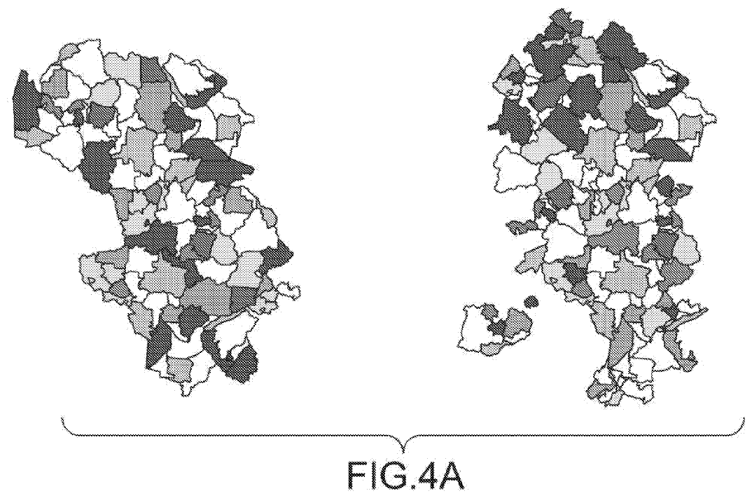

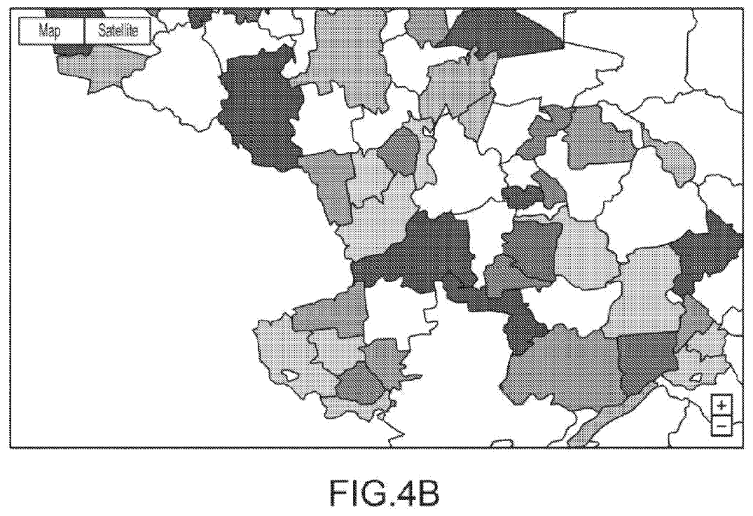

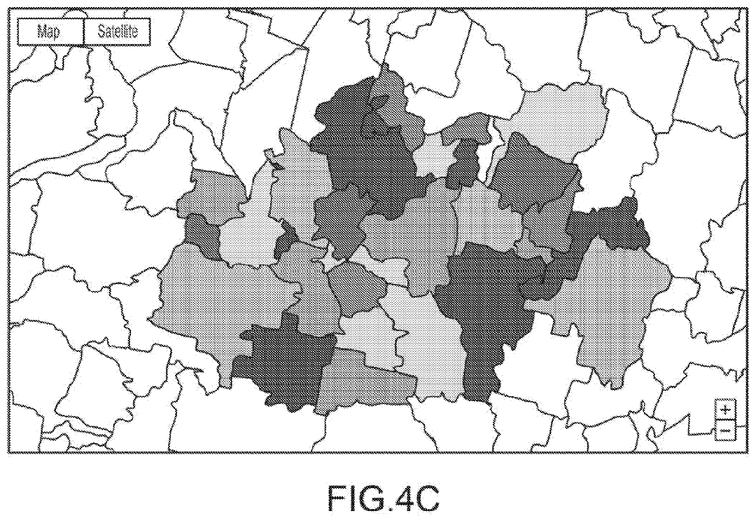

By georeferencing crash events, the process can work on proximity concept seeking for the best definition of areas and using other specific external information such as urban density. As a result, a new area risk definition based on crashes and effective customer mileage can be utilized. The new zoning classification can then be used as a factor of a predictive model. Examples of new zoning classifications can be seen from FIGS. 4A-4C.

FIG. 1 illustrates frameworks, models and data structures for analytical processes and model building. The data can include structured-data “certified” with native processing capacity (from raw data). Embodiments of the invention can include access to a powerful and flexible tool that provides control and data reliability, Embodiments of the invention can include using the platform as a Software As A Service in the analysis and definition of the KPIs of interest (SAS).

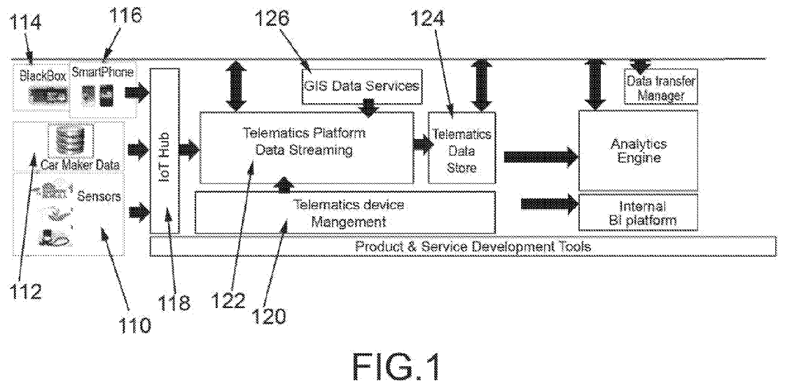

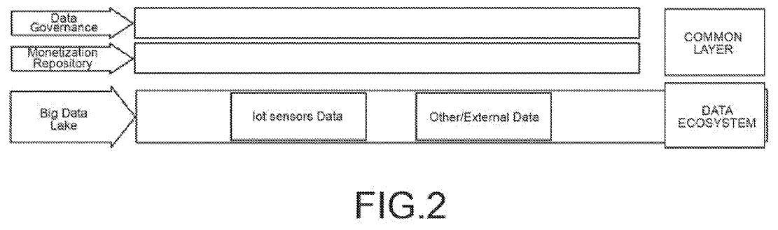

FIG. 2 illustrates that an architecture can gather data from device's transactions, attributes and external data to better characterize drivers' behavior and enrich knowledge.

Devices and drivers can be analyzed on several dimensions to spotlight their main features and behaviors. These dimensions can include:
Time and space;
Vehicle data;
Socio demographic data;
Contextual data (traffic, weather);
Accident information.

The architecture can allow assigning a score to a driver which positions the driver's profile in a scale relative to other drivers. All the multiple-driving style perspectives contribute to define the driver behavioral footprint or the Driver Global Score coming from a linear combination of his weighted patterns [subscores].

The subscores and the global score are the result of data driven statistical models based on SAS technology applied on Big Telematics Data collected about drivers' habits and behaviors over weeks and months from millions of devices installed in a worldwide Customer Base.

Thanks to the breadth of data in embodiments of the present invention, each driving style perspective is considered with reference to the context where it is performed providing the driving patterns of the policyholder. This can allow assigning a score to the driver which positions his pattern in a scale relatively to other drivers.

All the multiple-driving style perspectives contribute to define the driver behavioral footprint which is the Driver Global Score coming from a linear combination of his weighted patterns [subscores]. The subscores and the global score are the result of data driven statistical models based on SAS technology applied on Big Telematic Data collected about drivers' habits and behaviors over weeks and months from millions of devices installed in the CustomerBase worldwide.

The Data cycle, as defined above, allows the implementation of several data driven models, novel proprietary algorithms validated through backward re-processing of the entire data base, running in compliance with Data Protection directives as well as the more restrictive local regulations.

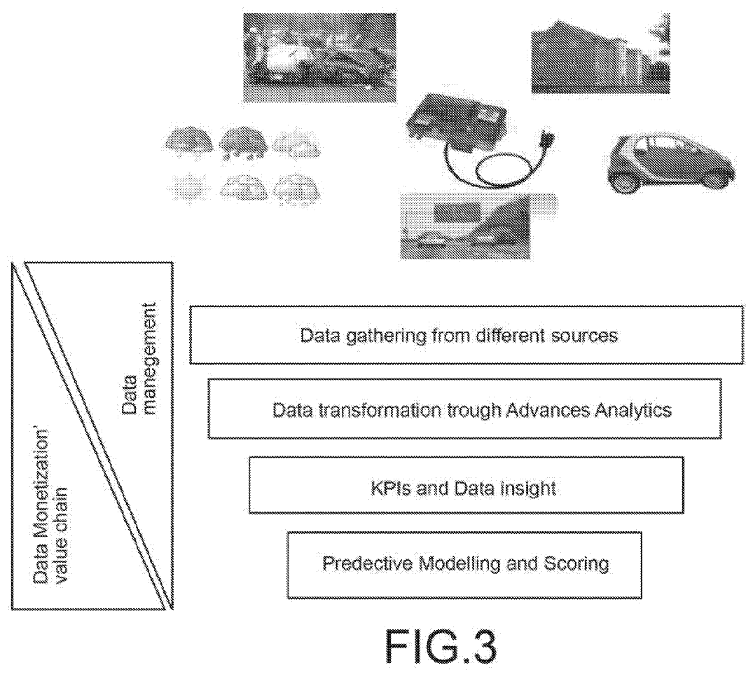

FIG. 3 illustrates the progression of data gathering to predictive modeling and scoring.

The behavioral footprint is a service leveraged by Big Telematics Data and analytics models which provides powerful insight to understand and score individual driving patterns raised as relevant by the statistical model application. These subscores represent the rank of a specific driving style of each policyholder with respect to the population analyzed under the same contexts.

This can be an important assumption as different contexts can rank differently the same driving style as they can be a strong influencer of it.

To better understand the power of the analytical model, it's necessary to consider the data cycle management which is based on a Common Layer, the layer where raw (based on historical Telematics data) have already been raised to the Business Environment through different steps of quality check, normalization, progressive enrichment.

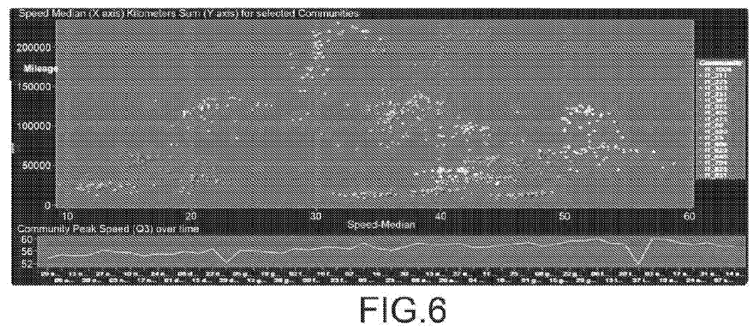

FIG. 6 shows benchmark analysis of speed and mileage distribution by community (according to particular types of day [working, Saturday, weekend], times of the day [morning, afternoon, night] and types of roads [urban, extraurban, rural]). As can be seen in FIG. 6, the communities (color coded from the key at the right) can have various spreads of speed and mileage distribution. Furthermore, the median speed for each community can vary, as shown in the graph at the bottom of FIG. 6. Crash or accident information can be overlaid on top of such data to determine the types, quantity and frequency of accidents in each particular area or community.

Indicators Based on GPS Positioning

The “Where” Indicator

Many years of statistical evidence show that driving in certain areas, or road types, etc., exposes the policyholder to a higher risk of crash with respect to other situations. Therefore, this is a “mature” indicator, meaning that a correlation between “where” a car is driven and risk is substantiated by objective elements.

Different insurance companies may have different criteria to classify roads and areas so as to define in detail a “where” indicator. A simple and popular approach is to distinguish builtup areas, motorways, and all the rest (that is essentially countryside areas excluding motorways). Administrative boundaries (e.g., provinces) may add-up to the above classification to refine the indicator. Some insurance companies would like that a larger number of road classes is considered to evaluate the indicator, but this is not usually recommended as it may lead to results that are too “granular” and too sensitive to the accuracy of the geographical database (even the most updated geographical databases from the major suppliers to not include the newest roads, road classes are generally estimated on the basis of debatable criteria, etc.). An optimum solution is usually a compromise between the criteria historically adopted by the insurance company to evaluate the location-dependent risk and the most similar indicator that can be reliably calculated through the geographical database.

The “When” Indicator

Statistical evidence also supports that driving in certain times of the day (or of the week) exposes the policyholder to a higher risk of crash. Rush hours during the day, or the weekend nights (especially for young drivers), can be typical examples. Again, this indicator is “mature,” as a correlation between “when” a car is driven and risk is substantiated by objective elements.

Insurance companies may have different criteria to classify periods of the day or of the week to be regarded as “high risk” vs. “low risk.” As in the case of the “Where” indicators, this is mostly related to criteria historically used by the insurance company to identify rush hours and other higher-risk conditions.

The “Where” and the “When” indicators can then be combined as a bi-dimensional indicator. The same principle may apply to the other indicators that will be described in the next paragraphs, so indicators with many dimensions can be defined. However, defining too complex indicators may jeopardize the “educational” aspect towards the policyholder: if users do not understand the indicators because they are too complex, they cannot improve their behavior. While multi-dimensional indicators are ideal for actuarial analysis, they are definitely not ideal from the policyholder's perspective. A trade-off between accuracy of the actuarial analysis and complexity shown to the policyholders can be made.

The “How much” Indicator

This indicator may be intended either in terms of driven distance (mileage) or in terms of driven time. Even though it is quite a mature indicator, its use to evaluate the risk of crash is still a bit controversial. Occasional drivers who travel very limited mileage/time may be more exposed to risk than frequent, experienced drivers. Nevertheless, being very easy to understand by anybody, this indicator is quite popular for pay-per-use tariffs, usually in multi-dimensional conjunction with “Where” and/or “When” indicators, regardless of it actually reflecting real exposure to risk.

The “How long” Iindicator

This indicator is related to the period of time driven without an interruption. Nominally, it should be a very mature indicator, as specific norms have been defined for the safety of professional drivers. However, the application of similar criteria to evaluate the risk exposure of non-professional drivers, even though limited to circumstances when relatively long journeys are made, has been rather neglected so far. Being easy to measure through telematics technologies (possibly in conjunction with “Where” or “When” indicators), and also quite easy to understand for the end user, this indicator would probably deserve more attention from a driving behavior viewpoint.

The “Speed” Indicator

The existence of speed limits almost everywhere is an indication that speed is recognized as a factor that influences the risk of accidents. However, the use of telematics technologies to regularly monitor the speed of a vehicle and draw conclusions on the actual exposure of the policyholder to the risk of an accident is still rather controversial.

The “Speed” indicator generally can be used in conjunction with “Where” indicators, as the level of danger associated to speed is much different depending on whether the vehicle is, say, on a motorway rather than in a small country road or in a urban area. Technically speaking, any combination of speed with other indicators can be made, but this always leaves room to the objection that a low value of speed may be much more risky than a high value of speed depending on the specific context (e.g., in a very dense traffic flow with respect to a completely desert motorway).

The specific way speed is measured is also a bit controversial. Some insurance companies think that the instantaneous speed is the most significant factor. However, instantaneous speed as measured by GPS is more affected by errors (typically due to multipath, i.e., reception of a GPS signal reflected by some objects nearby the vehicle), so the accuracy may not be optimum. Other insurance companies consider the average speed over a short period of time, as norms related to professional drivers require the evaluation of the average speed in a one-minute period. Standard recording principles can accommodate both viewpoints: all records include the instantaneous speed as well as the distance driven and time with respect to the previous record. By dividing the driven distance by time, the average speed between consecutive records can be easily derived.

Indicators Based on Accelerometer and Gyroscope

The indicators described in the next paragraphs can be used in terms of objective recognition about their validity as potential risk factors. In summary, as nobody in the past has systematically measured such indicators, nobody has been able to demonstrate, through significant statistics, a correlation between such indicators and the actual risk of accident. Embodiments of the invention include validating these types of indicators to determine whether drivers showing higher values for some of these indicators correspond to those having a worse score for accident risk. The indicators described in the next paragraphs are based on a common concept: the evaluation of the “safety margin”. The basic principle is the following: accidents tend to occur when something happens that is unexpected for the driver, and the driver is unable to react in such a way that the accident can be avoided (e.g., by braking and/or steering). If the driver had more possibilities to accommodate corrective maneuvers, he/she would probably be able to avoid the accident, or, at least, to reduce the damages to vehicles and/or persons. Such possibility to perform corrective maneuvers is the “safety margin” that innovative indicators try to evaluate.

The “Cornering” Indicator

This indicator can evaluate whether the driver tends to drive through corners at a speed that is relatively high with respect to the radius of the corner. If anything unexpected occurs (e.g., something to avoid, road surface being suddenly wet or slippery, etc.), the driver has no margin to change direction and undertake a corrective maneuver.

Some expert drivers (e.g., instructors of safe driving) retain that many crashes could be avoided if drivers knew more precisely how much steering performance their cars provide. They think that people who never experience the full steering capabilities of their cars are unable to use such capabilities in the case of an emergency maneuver aimed at avoiding an accident. Instead, drivers who are familiar with the full steering capabilities of their cars may be more prompt to exploit them in the case of need. So, from their viewpoint, “cornering” drivers may be less exposed to risk than“non-cornering” drivers. These opinions highlight the need of a correct validation process to ensure that the indicators chosen are objectively related, at least statistically, to the risk of accident.

The measurement of this indicator is based on the transversal acceleration (“Y” axis, i.e., the axis perpendicular to the vehicle's movement). Y-axis acceleration samples are continuously measured and properly filtered to remove measurement noise. Specific records are present within the overall data reporting scheme, storing significant summary information about the transversal acceleration measured in the interval of time/space between two consecutive records. Statistical evaluations (e.g., distribution of the values collected) are then made in the central systems, and possibly correlated with other indicators (e.g. “Where” and/or “When”).

The “Direction Changing” Indicator

This indicator can evaluate whether the driver tends to rapidly change direction, for example when changing lanes on a multiple-lane road. If anything unexpected occurs (e.g., another car is moving to the same lane) the driver has no margin to change direction and undertake a corrective maneuver.

The measurement of this indicator is based on the transversal acceleration, similarly to the “Cornering” indicator. “Direction Changing” can be distinguished from “Cornering” as the duration of acceleration events is typically shorter.

The “Racing” Indicator

This indicator can evaluate whether the driver tends to use a lot of the vehicle's accelerating and braking power whenever possible. If anything unexpected occurs (e.g., something to avoid, road surface being suddenly wet or slippery, etc.), the driver has little margin to undertake a corrective maneuver (slow down and brake).

As in the case of the “Cornering” indicator, some discussions still exist about the validity of this indicator to evaluate the risk. Some expert drivers retain that people who never experience the full braking capabilities of their cars are unable to use such capabilities in the case of an emergency maneuver aimed at avoiding an accident. So, from their viewpoint, “Racing” drivers may be less exposed to risk than “non-racing” drivers.

In principle, the measurement of this indicator can be made via GPS, by analyzing the variations of speed, or directly through the acceleration sensor. However, the measurement of speed via GPS may be affected by errors due to multipath, and calculation of derivatives tends to amplify the effects of such errors. Therefore, embodiments of the present invention make use of the acceleration sensor to this purpose, similarly to the “Cornering” indicator, but using the longitudinal axis (“X” axis”) rather than the transversal axis (“Y” axis).

The “Tailgating” Indicator

This indicator can evaluate whether the driver tends to closely follow the vehicle in front of their car, possibly staying close or beyond the safe headway clearance. This leaves the driver with a smaller margin to react in the case anything unexpected occurs.

A sensor for this indicator according to some embodiments of the invention would be a direct measurement of the headway clearance using optical or radio-frequency technologies. Sensors of this type can be introduced on cars at the time of manufacture, or they can be installed on cars not equipped from factory. However, the number of cars equipped from factory, or the complexity and costs to equip other cars, are such that the use of a headway clearance sensor is not cost effective at the moment.

The “Tailgating” indicator may be evaluated through an indirect process. Drivers who closely follow another vehicle tend to frequently accelerate and decelerate. If compared with the “Racing” behavior the values of acceleration can be quite smaller, however the frequency of acceleration and deceleration can be larger. Therefore, the measurement principles can be similar to the “Racing” indicator, but frequent and repeated changes of sign of the acceleration (positive to negative and vice versa) on the “X” axis are accounted rather than larger and more occasional “peaks” (positive or negative).

Validation of Innovative Indicators

As described in the previous paragraphs, the relationship between certain indicators and the risk of accident is not yet demonstrated and, in some cases, even a bit debatable. Validating the indicators with respect to the risk may not be made by the provider of telematics services alone: the cooperation of the insurance company may be required.

Two possible approaches can be used for validation:

With “apriori” knowledge. An experimentation campaign is carried out with a significant population of “sample” policyholders whose exposure to risk is known already by the insurance company through their historical record of claims. Indicators are evaluated for a period of time. Validation occurs if policyholders more exposed to risk (based on the “a priori” knowledge) show larger values of the indicators. This approach is supposed to provide results in a shorter time and with a smaller population of policyholder, however its accuracy is somewhat affected by the accuracy of the “a priori” knowledge about individual exposure to risk; and

Without “a priori knowledge”. An experimentation campaign is carried Out with a random population of policyholders. The population and the duration of the experimentation can be sufficient to allow that a significant number of accidents happens during the observation period, so that the risk exposure of individuals can be evaluated on the basis of actual accidents. Validation occurs if policyholders more exposed to risk (based on the actual accidents occurred rather than on the “a priori” knowledge) show larger values of the indicators. This approach is supposed to require a larger population and longer observation time to achieve statistically stable results.

The above approaches are not mutually exclusive, and they can actually be performed as two phases of a plan distributed over multiple years.

The validation process used in embodiments of the invention leverages validated crashes into our predictive model and, in those cases where such information is available, on claims information from insurance companies.

For the statistical evaluation, all the drivers can be represented by their driving patterns, each of them based on a “driving style perspective” considered in a “specific context.” The driving style perspectives are based on the following parameters according to the four basic scores:

Speeding—this parameter provides a rank with respect to the speed. Speed is considered both as the instant speed provided by data collected from devices according to a proprietary protocol and the average speed calculated at a statistical level with reference to a predefined context.

Linear driving behavior This parameter provides the driver style with respect to the acceleration and braking as defined previously. These events are described by five measures: start and end speed, duration, average acceleration, maximum acceleration with reference to a pre-defined context.

Cornering—This parameter provides the driver pattern with respect to the cornering as defined above. Similarly with Linear driving behavior events, Cornering are described by five measures: start and end speed, duration, average acceleration, maximum acceleration with reference to a pre-defined context.

Mileages in different weather conditions—this parameter provides the driving style respect to the weather condition in which mileages are generated (i.e., weather contexts).

All these driving style parameters are considered with respect to different contexts they were generated.

The table shows the complete contexts considered for Speed, Linear Driving Behavior, Cornering Driving Behavior.

| Context | Feature |
|---|---|
| Day/Type | !working day |
| | !Saturday |
| | !Sunday/holiday |
| Day/Time | !Morning (07-13 local time) |
| | !Afternoon (14-20 local time) |
| | Evening (21-23 local time) |
| | !Night (24-06 local time) |
| Space | Road type mapping (U/E/H), |
| | geographical community |

The above table illustrates that the total combination of contexts considered can be 36, which is 3 (type of day)×4 (time of day)×3 (roadtype−H/U/C),

Each driving style considered in the context where it is generated defines a Driving Pattern. All the values for each driving style parameter tune windows) are predefined and normalized to allow the correct application of the statistical model and infer the right observations. As mentioned the Linear and Cornering Score can be defined by acceleration, braking, and cornering events which are measured with five measures: average acceleration, maximum acceleration, end and start speed and duration. In addition to the five measures, a sixth measure can be intensity, which includes the frequency of measurements (e.g., in units of time or distance)

Each of these measures produces a distribution in each of the combined contexts. These distributions are described with specific KPIs (first and third quartile, median, max). The Speed Score is defined by instant speed which produces a distribution in each of the combined contexts.

Another KPI can be defined as average speed of each context.

The service goal is to rank each driver through a benchmark of his driving pattern (driving style analyzed in a context) with respect to the same driving pattern and basic score of each country.

So, for example, this service allows for answering how the driver is ranked if benchmarked with respect to other drivers of population. The following two points can be considered:

1) the driver's “Median Instant Speed” during the night or on urban roads and specific road type, or
2) the driver's maximum strength of his brake, occurred during the day, on motorway during weekends etc.

Naturally, a driver is featured by several contexts defining his patterns and he can be compared/benchmarked with respect to all the contexts meaningful to each of his driving style perspectives.

The models and concepts described hereafter fulfill the above requirements.

Global individual Scoring as Behavioral Footprint

The weights can be assigned through different methods described below:
Business company needs;
Each pattern (driving style in a context) can be weighted on a data driven base, such as its informative power (such as its non-missing relevance or its variability) among all measures;
Leveraging the predictive models based on crash information

Frequency of Statistical Processing (Score/Subscores and Contexts)

The service provides the calculation of the following scorings (driving patterns and behavioral footprint) listed below:
[S] Speeding
[La Lb]Linear driving behavior (acceleration/braking)
[C] Cornering
[M] Exposure to dangerous Weather conditions
[O] Overall Score equals the weighted combination of the 4 subscores

All the scores can be shown as a discrete presentation in a range from 0 to 1 where it can:
represent the best scoring; or
represent the worst scoring

Drivers having the best absolute scores can have score values close to zero. The scores will have a daily/weekly/month calculation frequency.

In case of absence of data the score will be shown as “not available” with the related reasons (no trips during the weeks, no data collected for reasons of . . . ).

Propensity to Context Usage (Systematic Mobility)

In addition to the pattern and footprint, some additional information can be provided that shows the driver attitude (systematic mobility) with respect to the contexts of usage. In particular with the same frequency of the scores will be provided for each user the following information:
[p1] Propensity to move across several areas/communities [1 area or multiple areas] or propensity to travel in risky areas/communities;
[p2] Propensity to travel different time during the days [1 time window or multiple time window];
[p3] Propensity to travel in different days;
[p4] Propensity to travel in different road type;
[p4] Propensity to travel in different weather states.

Propensities of context are derived with heterogeneity Gini index as a measure of the statistical variability for categorical variables. A Gini index of zero expresses perfect equality, a Gini coefficient of one expresses maximal inequality among values.

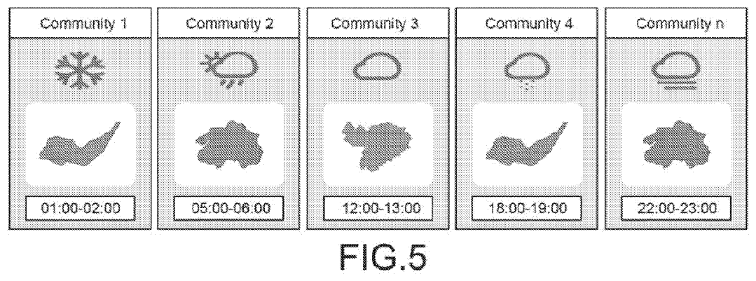

As shown in FIG. 5, weather information can be collected for each community in each period of the day/night.

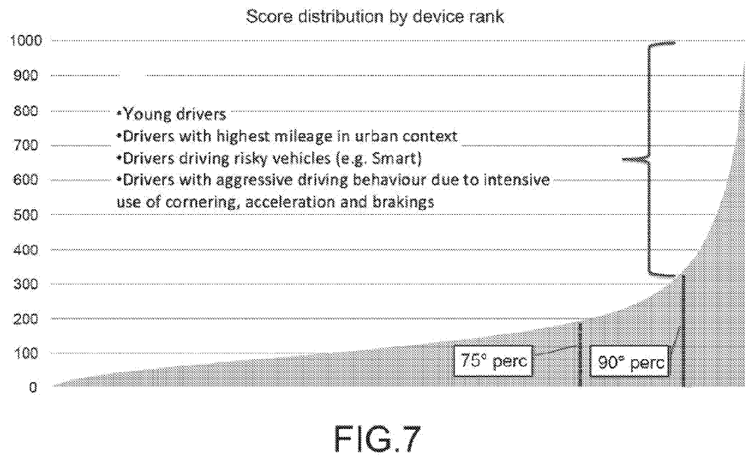

FIG. 7 shows a predictive model based on Telematic variables that can improve pricing accuracy, identifying the less risky clients. Embodiments of the invention can include data associated with the number of devices; the mileage; the number of events; the number of braking/accelerations; the number of cornering instances; the number of validated crashes; the number of weather detections; the accident risk information of each type of areas/communities; and the number of vehicle information.

With such information, different demographics can be analyzed for improved accuracy, For example, rather than young drivers collectively being labeled as risky, risk can be attributed to a percentage of young drivers. Thus, while a higher percentage of young drivers may be classified as risky in relation to other drivers as a whole, itis possible for a good percentage of young drivers to be classified as not risky. Thus, a subset of a previously risky group can be more accurately identified based on the predictive model and analytics. Also, while some services may label a geographical area as risky (such as urban, a particular city, or a county), embodiments of the invention can isolate risky areas/communities more accurately by clustering accident information of the population of drivers.

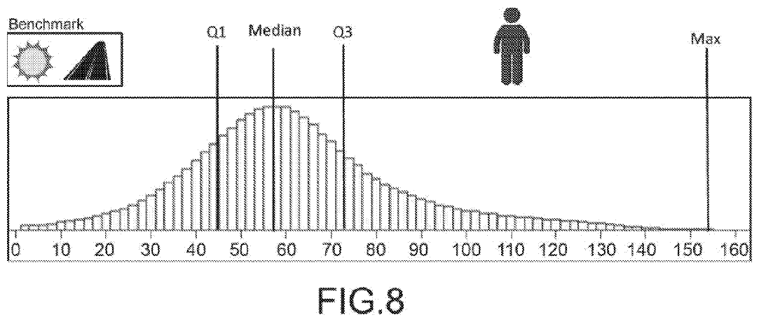

As shown in FIG. 8, other examples of demographics that can be analyzed are drivers with the highest mileage in urban areas, drivers with risky vehicles (e.g., Smart), drivers with aggressive driving behavior due to intense use of cornering, acceleration and brakings.

Pattern Analysis

Fig, 8 shows a period of observations (i.e., a month) of collected measures (Instant Speed) for a specific context (benchmark) for policy holder X. In FIG. 8, the context is Morning (7:00-14:00) and Extra. Urban Roads. Further, Median, 1st Quartile, 3rd Quartile and Max have been calculated as the most relevant statistics on the measure distribution (Instant Speed). Each benchmark can represent a specific context. It can represent drivers' behavior in specific contexts (i.e., Morning and Extra Urban). And benchmarks can provide values for evaluating individual driver risk patterns since behavior is not irregular in itself, but it's relative to the context in which it takes place.

The following general requirements can be taken into account in some embodiments of the invention:

Sustainability: the costs to evaluate behaviors should be consistent with the benefits that the insurance company and the policyholder may obtain;

Feasibility: as a specific component of sustainability, the measurement principles should be such that they are feasible using reliable technologies available at reasonable costs. The operational stability and economy of scale offered by “insurance telematics services” can be considered as a starting point for the development of innovative concepts on top of them;

Accuracy: the measurement principles should be such that behaviors can be evaluated with reasonable accuracy, and a validation process can be supported, if necessary, to demonstrate objective correlation between behavior and risk; and

Applicability: as far as possible, the concepts should have general fundamentals and applicability, so that in principle they can be applied by any insurance companies allowing a customization level that does not impair other requirements (e.g., that maintains the economy of scale necessary for sustainability).

This allows to shape driver driving patterns (perspectives of driving style in different contexts) and benchmark them with a wider population of each country, in order to define a score related to a specific policyholder.

In describing embodiments, specific terminology is employed for the sake of clarity. However, the invention is not intended to be limited to the specific terminology and examples selected. A person skilled in the relevant art will recognize that other equivalent components can be employed and other methods developed without departing from the broad concepts of the current invention.

Although the foregoing description is directed to the preferred embodiments of the invention, it is noted that other variations and modifications will be apparent to those skilled in the art, and may be made without departing from the spirit or scope of the invention. Moreover, features de-scribed in connection with one embodiment of the invention may be used in conjunction with other embodiments, even if not explicitly stated above.

What is claimed is:

1. A computer system for assessing vehicle risk, comprising:
a data storage device storing instructions; a data processor that is configured to execute the instructions to cause the computer system to:
provide aggregated vehicle data for a plurality of vehicles including location data of the plurality of vehicles; determine at least one geographic area to be analyzed for the aggregated vehicle data; receive event information of the plurality of vehicles in the at leak one geographic area, the even information including location information of a predetermined type of event; determine boundaries of a plurality of geographic communities within the at least one geographic area based on the received event information of the plurality of vehicles; and assigning a risk profile to each of the determined geographic communities based on the event information in each geographic community.

2. The system of claim I, wherein the determining the plurality of geographical communities is based on proximity clustering of the event information of the plurality of vehicles.

3. The system of claim 1, wherein the geographical communities are polygon-shaped.

4. The system of claim 1, wherein the event information includes incidence of crashes, strength of crashes and analysis of crashes for the plurality of vehicles.

5. The system of claim 1, wherein the risk profile of each geographical community includes a score that corresponds to a degree of risk of getting in an accident associated with the geographical communities.

6. The computer system of claim 5, wherein the score is discrete, the discrete score being one of a predetermined number of discrete categories.

7. The computer system of claim 5, wherein the score of the geographical community is continuous, the continuous score including a scaled value.

8. The computer system of claim 1, wherein the processor is further configured to cause the computer system to:
determine patterns of the plurality of vehicles using the calculated driving style perspectives in relation to the predetermined set of contexts and in the geographical communities; and calculate indicators for the plurality of vehicles by using at least one measured parameter for the determined driving patterns, wherein the risk profile for the geographical communities is determined based on the calculated indicators of the plurality of vehicles.

9. The computer system of claim 8, wherein the at least one measured parameter includes at least one of speeding, linear (hiving behavior, cornering and mileage.

10. The computer system of claim 8, wherein one of the indicators is a linear and cornering parameter, the linear and cornering indicator being measured using acceleration, braking, and cornering measurements of the plurality of vehicles in all the geographical communities benchmarked against a plurality of vehicles in a particular geographical community.

11. The computer system of claim 10, wherein the score of each geographical community is generated by measuring indicators using average acceleration, maximum acceleration, end and start speed and duration of the plurality of vehicles in all the geographical communities and benchmarking the indicators against a plurality of vehicles in a particular geographical community.

12. The computer system of claim 11, wherein the measuring the indicators further uses intensity of the plurality of vehicles.

13. The computer system of claim 12, wherein the total score is between 0 and 1.

14. The computer system of claim 11, wherein the processor is further configured to generate a distribution of each of the driving patterns, and wherein the benchmarking includes using the distribution to compare geographical communities.

15. The computer system of claim 14, wherein the distributions including a plurality of key performance indicators, the key performance indicators including threshold values in first quartile, median, third quartile and maximum ranges.

16. The computer system of claim 8, wherein one of the indicators is a speed parameter, the speed parameter being measured from an instant speed of the particular vehicle.

17. The computer system of claim 1, wherein the data processor is further configured to normalize the predetermined parameters, wherein the assessing the particular vehicle uses a statistical model of the normalized predetermined parameters.
